(19) United States
(12) Patent Application Publication
(10) Pub. No.: US 2026/0310196 A1
(43) Pub. Date: Oct. 8, 2026

(54) Method and Control Unit for Enabling a Remote Control Service for a Vehicle

(71) Applicant: Bayerische Motoren Werke Aktiengesellschaft, Muenchen (DE)

(72) Inventors: Joachim FLEIG, Reichertshausen (DE); Marco HIPPLER, Muenchen (DE); Lukas REINHART, Freising (DE); Michael REITHMEIER, Eichenau (DE); Clemens SCHAEFER, Donauwoerth (DE)

(21) Appl. No.: 19/482,811

(22) PCT Filed: Apr. 22, 2024
(86) PCT No.: PCT/EP2024/060877

§ 371 Date: Nov. 10, 2025

(30) Foreign Application Priority Data
May 15, 2023 (DE) 10 2023 112 688.1

(51) Int. Cl. G05D 1/227; B60R 25/04; B60R 25/24; G05D 109/10; G05D 111/30; H04L 9/40

(52) U.S. Cl. CPC G05D 1/227; B60R 25/04; B60R 25/24; H04L 63/061; H04L 63/0853; B60R 2025/0415; G05D 2109/10; G05D 2111/32

(57) ABSTRACT

A method for enabling a remote control service for a vehicle. The method comprises receiving a handover request for handing over control of the motor vehicle to a control unit of the remote control service, the handover request comprising context information regarding the permissible context of the remote control service. The method also includes receiving a mission request for a remote control service mission, and checking the validity of the mission request based on the context information. Further, the method includes, depending on the checking step, triggering the vehicle to execute the remote control service mission initiated by the control unit.

### BACKGROUND AND SUMMARY

The invention relates to a method and to a corresponding control unit for enabling a remote control service for a (motor) vehicle.

A vehicle can comprise one or more functions which can be remotely controlled by a user of the vehicle by means of an electronic device such as, e.g. a smartphone. One exemplary vehicle function is the opening and/or closing of a door or hatch of the vehicle and/or the execution of an automated parking process. Remote control of one or more vehicle functions is typically executed by means of a wireless communications link between the vehicle and the electronic (key) device, while the electronic device is arranged in proximity to the vehicle.

A user of a vehicle may wish to enable another entity (e.g. a service provider) to execute one or more vehicle functions, in particular an automated parking maneuver, of the vehicle, without the necessity for the electronic device of the user to be arranged in proximity to the vehicle for this purpose.

The present document addresses the technical object of enabling an off-vehicle unit, in a secure manner, and even in the absence of a locational and/or temporal presence of a key device, to execute the remote control of a vehicle function, in particular the release of the immobilizer of the vehicle.

This object is fulfilled by each of the independent claims. Advantageous embodiments are described, inter alia, in the dependent claims. It is hereby observed that additional features of a patent claim which is dependent upon an independent patent claim, in the absence of the features of the independent patent claim, or in combination with only a subset of the features of the independent patent claim, can constitute a standalone invention which is independent of all the features of the independent patent claim, which invention can form the subject matter of an independent claim, a divisional application or a subsequent application. The same applies, in an equivalent manner, to the technical instruction described in the description, which technical instruction can form an invention which is independent of the features of the independent patent claims.

According to one aspect, a method is described for enabling a remote control service for a (motor) vehicle (e.g. for a passenger vehicle, a heavy goods vehicle, a bus and/or a motorcycle), in particular for the remote control of a vehicle. The method can be executed by a controller of a system, wherein the system moreover comprises the vehicle and a control unit for controlling the remote control service. The controller and the control unit are separate units which are configured to communicate via a communications link (in particular a remote communications link, for example a wide area network, or WAN). The controller and control units are typically operated by different (legal and/or organizational) entities. The controller can be operated by a manufacturer of the vehicle. The control unit can be operated by a service provider of the remote control service. Typically, the controller and the control unit are spatially separated, e.g. by a distance of 10 km or more.

Typically, the system further comprises an electronic key device (in particular, a portable user device, for example a smartphone) of a user of the vehicle. The key device can comprise a digital key. The digital key can be configured in accordance with the Car Connectivity Consortium (CCC) key standard, particularly in accordance with CCC Release 3. The digital key can be configured to enable the key device to execute the control of one or more vehicle functions of the vehicle. Exemplary vehicle functions include the opening and/or closing of a vehicle door, and/or the start-up and/or switch-off of the drive motor of the vehicle, and/or the automated and/or remote-controlled parking of the vehicle.

The method comprises the reception of a handover request, which request is transmitted by the key device, for the handover of the motor vehicle to the remote control service, in particular to the control unit of the remote control service. The handover request can be intended to execute the handover of an entitlement for the remote control of one or more vehicle functions of the motor vehicle to a remote control service, in particular to the control unit of a remote control service. The handover request can comprise contextual information regarding the permissible context of the remote control service. Contextual information can indicate:
the permissible geographical range for one or more missions of the remote control service;
the permissible time period for one or more missions of the remote control service; and/or
one or more vehicle functions of the vehicle, the remote control of which by the control unit is permitted in the context of a mission of the remote control service.

Contextual information can thus describe and/or define the context (which is defined by the user of the key device) for the execution of the remote control service.

The method further comprises the reception of a mission request for a mission (e.g. for a specific journey) of the remote control service which is transmitted by the remote control service, in particular by the control unit of the remote control service. A mission of the remote control service can comprise and, in particular, can constitute an action, a process, a deployment and/or an assignment of the remote control service. In particular, a mission of the remote control service can alternatively be described as an action, a process, a deployment and/or an assignment of the remote control service.

The mission request for the mission of the remote control service can indicate: the geographical range of the mission;
the duration of the mission; and/or
the one or more vehicle functions of the vehicle, the remote control of which by
the control unit is to be executed in the context of the mission.

The handover request and/or the mission request can be transmitted by the respective sender (i.e. by the key device or by the control unit) and received either directly or indirectly (e.g. via one or more intermediate communications stages) by the controller.

The method moreover comprises a verification of the permissibility of the mission request, on the basis of contextual information. In particular, a check can be executed as to whether the requested mission falls within the scope of the context for the remote control service which is defined by contextual information, or otherwise.

Depending upon the check thus executed, the vehicle can then be triggered (or, in the event of a failed check, not triggered) to execute the mission of the remote control service (which is initiated and/or requested by the control unit). In the event that the requested mission falls within the scope of the context thus defined, the vehicle can be triggered to execute the mission of the remote control service. On the other hand, execution of the mission of the remote control service can be inhibited, in the event that the requested mission falls outside the context thus defined. In particular, the vehicle can be triggered (in the event of a successful check) to release the electronic immobilizer of the vehicle, in order to execute, or to enable the execution of the mission of the remote control service. In practice, remote control of the vehicle for executing the mission can be executed by the control unit of the remote control service.

A central (off-vehicle) controller can thus be provided, which controller, in a secure manner, enables the execution of one or more missions of a remote control service, even in the absence of a locational and/or temporal presence of the key device. In particular, for the execution of the mission of the remote control service, it is possible that no further communication between the key device and the vehicle is required.

The method can comprise the reception of a cryptographic session signature of the key device, in combination with the handover request. The session signature can be based upon the digital key of the key device. Verification of the handover request and/or of contextual information, in particular of the authenticity of the handover request and/or of contextual information, can then be executed in a particularly reliable manner on the basis of the cryptographic session signature. Optionally, it is then possible for the handover request and/or for contextual information only to be considered in the event that a successful authentication of the handover request and/or of contextual information has been successfully executed.

The method can comprise the reception of a request (which is transmitted by the key device) for the set-up of key data for an enablement of the vehicle for remote control services. Key data can then be generated in response to the request. A first element of key data can be saved in a (secured) key memory module of the controller. Moreover, a second element of key data (in particular for the key pair) can be transmitted to the vehicle (and saved therein). By the generation of key data, a particularly secure and robust enablement of remote control services for the vehicle can be effected. In particular, it can be effected that the first element of key data for the enablement of the vehicle for remote control services which is saved in the key memory module of the controller is transmitted to the vehicle, in order to trigger the execution by the vehicle of the remote control service (in particular, the release of the immobilizer).

The method can comprise the reception of authentication data for the authentication of the key device, in combination with the above-mentioned request. Authentication data can be based upon the digital key of the key device. An authentication of the request can then be executed on the basis of authentication data, and it can be effected that key data for an enablement of the vehicle for remote control services are (only) enacted further to the (successful) authentication of the request. A particularly secure enablement of the vehicle for remote control services can thus be effected.

The method can comprise the reception of availability data which have been transmitted by the remote control service, in particular by the control unit of the remote control service, to the effect that the remote control service, in particular the control unit of the remote control service, is available for the provision of the remote control service. Thereafter, availability information with respect to availability data thus received can be transmitted to the key device. Reception of the handover request can be executed (optionally, only) in response to the transmission of availability information. Robustness of the delivery of a remote control service can thus be further enhanced.

According to a further aspect, a software (SW) program is described. The SW program can be designed for the running thereof on a processor, in order to execute the method described in the present document.

According to a further aspect, a storage medium is described. The storage medium can comprise a SW program which is designed for the running thereof on a processor, in order to execute the method described in the present document.

According to a further aspect, a controller (e.g. having one or more computing units, for example servers) is described for enabling a remote control service for the remote control of a motor vehicle. The controller is designed to receive a handover request which is transmitted by a key device for the handover of the motor vehicle to the remote control service, in particular to a control unit of the remote control service, wherein the handover request incorporates contextual information with respect to the permissible context for the remote control service, or with respect to the remote control service. The controller is further designed to receive a mission request for a mission of the remote control service for the remote control of the motor vehicle which is transmitted by the remote control service, in particular by the control unit of the remote control service, and to execute a check of the permissibility of the mission request, on the basis of contextual information. The controller is moreover designed, depending upon the check of the vehicle, to trigger the execution by the vehicle of the mission of the remote control service (which is initiated and/or requested by the control unit).

According to a further aspect, a key device of a user of a motor vehicle (e.g. a mobile user device, for example a smartphone) is described. Moreover, a method corresponding to the key device is described. The key device is designed to transmit a handover request for the handover of the motor vehicle to a remote control service (in particular for the handover of the motor vehicle to the control unit of a remote control service). The handover request can incorporate contextual information with respect to the permissible context for the remote control service. The key device and/or the corresponding method can (arbitrarily) comprise one or more of the features described in the present document in conjunction with a key device.

According to a further aspect, a control unit is described for providing a remote control service for the remote control of a motor vehicle. Moreover, a method corresponding to the control unit is described. The control unit is designed to transmit a mission request for a mission of the remote control service for the remote control of the motor vehicle to a controller for the enablement of the remote control service. The controller can be configured as a backend of the motor vehicle. The control unit and/or the corresponding method can (arbitrarily) comprise one or more of the features described in the current document in conjunction with a control unit.

According to a further aspect, a motor vehicle is described, which motor vehicle comprises one or more vehicle functions which can be remotely controlled. Moreover, a method corresponding to the motor vehicle is described. The motor vehicle is configured to be triggered by an off-vehicle controller for the execution of a mission of a remote control service for the remote control of the motor vehicle (wherein the mission of the remote control service has been requested by a separate, off-vehicle control unit). The motor vehicle and/or the corresponding method can (arbitrarily) comprise one or more of the features described in the present document in conjunction with a vehicle.

According to a further aspect, a system and a corresponding method are described. The system comprises a controller, a control unit, at least one key device and at least one vehicle, each of which is configured as described in the present document.

It should be observed that the methods, devices and systems described in the present document can be employed both in isolation and in combination with other methods, devices and systems described in the present document. Moreover, any aspects of the methods, devices and systems described in the present document can be mutually combined in a variety of ways. In particular, the features of the claims can be mutually combined in a variety of ways. Moreover, features which are enclosed in brackets are to be understood as optional features.

The invention is described in greater detail hereinafter with reference to exemplary embodiments.

### BRIEF DESCRIPTION OF THE DRAWINGS

FIG. 1a shows an exemplary digital access system of a vehicle;

FIG. 1b shows an exemplary application situation for a digital access system;

FIG. 2 shows exemplary messages between a vehicle and a digital key device;

FIG. 3 shows an exemplary system for the remote control of a vehicle function of a vehicle;

FIGS. 4a, 4b and 4c show flow diagrams of exemplary methods for saving key data for a remote control service;

FIGS. 5a, 5b and 5c show flow diagrams of exemplary methods for the handover of the vehicle to the control unit of a remote control service provider;

FIGS. 6a, 6b and 6c show flow diagrams of exemplary methods for the release of a remote control mission of the remote control service; and

FIG. 7 shows a flow diagram of a method for the enablement of a remote control service for a vehicle.

### DETAILED DESCRIPTION OF THE DRAWINGS

As described above, the present document addresses the secure enablement of a remote control service provider for the remote control of a vehicle function of a vehicle 100, without the employment of a digital key device 110.

FIG. 1a shows an exemplary (access) system 150 which comprises at least one vehicle 100 and a digital key device 110. Typically, the digital key device 110 is a portable electronic device, such as e.g. a smartphone or a tablet PC, wherein a digital key 111 is saved on the portable electronic device. The digital key 111 can be saved in a protected memory area, in particular in a “secure element” of the portable electronic device (for example of the user device).

The digital key device 110 is configured to communicate with a communications unit 102 of the vehicle 102 via one or more different wireless communications links 112. The different communications links 112 can be employed for different purposes. In particular, a Bluetooth Low Energy (BLE) communications link 112 can be employed:
for determining the distance and/or the relative position between the digital key device 110 and the vehicle 100 (in particular, on the basis of the signal strength, in particular the RSSI (Received Signal Strength Indicator) of wireless signals which are exchanged between the vehicle 100 and the device 110; and/or by the employment of BLE Channel Sounding (mode 2/phase-based measurements)); and/or
for exchanging data between the digital key device 110 and the vehicle 100 (e.g. a control command for controlling a vehicle function 103, for example the unlocking of a door, and/or the opening or closing of a window, and/or the activation or deactivation of a heating function, and/or the activation or deactivation of the drive motor of the vehicle 100).

Alternatively or additionally, an ultrawideband (UWB) communications link 112 can be employed for determining the position of the device 110 relative to the vehicle 100 with a relatively high degree of accuracy. Determination of the position of the device 110 by the employment of an UWB communications link 112 can be described as UWB ranging.

A (control) device 101 of the vehicle 100 can be configured to control at least one vehicle function 103 of the vehicle 100 in accordance with communication between the device 110 and the vehicle 100, as for example, represented in FIG. 1b. In this context, the digital key 111 of the device 110 can be verified and, in particular, authenticated. Moreover, further to a successful authentication, one or more vehicle functions 103 can be controlled, particularly in accordance with:
the distance between the device 110 and the vehicle 100;
the location of the device 110 relative to the vehicle 100; and/or
a control command which is transmitted by the device 110 to the vehicle 100 via a communications link 112.

In an exemplary system 150, a BLE communications link 112 can be established immediately between the device 110 and the vehicle 100, once the distance between the device 110 and the vehicle 100 is equal to or lower than a first distance threshold value 121. This enables the user, by the employment of the device 110, to execute a remote control of one or more vehicle functions 103. The vehicle 100 typically executes a repeated indication, e.g. at a specific frequency, of the availability of a BLE communications link 112. With effect from the first distance threshold value 121, the device 110 (which can also be described as “user equipment” (UE)) receives the indication message from the vehicle 100 and, thereafter, the BLE communications link 112 can be established between the device 110 and the vehicle 100. The first distance threshold value 121 can be dependent upon the communication capabilities of the device 110, upon the environment of the vehicle 100 and/or of the device 110, and/or upon the position of the device 110 relative to the vehicle 100.

Furthermore, an UWB communications link 112 can be established between the device 110 and the vehicle 100, immediately once the distance between the device 110 and the vehicle 100 is equal to or lower than a second distance threshold value 122 (which can be lower than the first distance threshold value 121 and/or which can be dependent upon the communication capabilities of the device 110). On the basis of the UWB communications link 112, the location of the device 110 can be determined with a relatively high degree of accuracy. By means of the UWB communications link 112, optionally, one or more further vehicle functions 103 can be controlled (additionally to the one or more functions 103 which can be controlled by means of the BLE communications link 112).

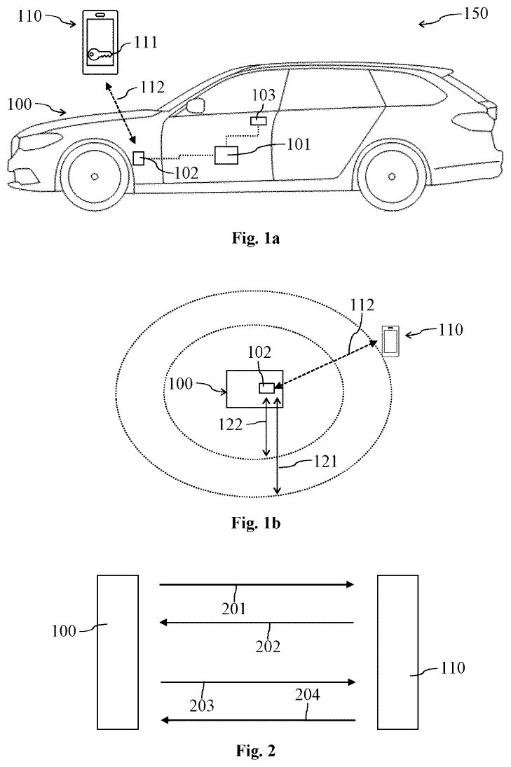

FIG. 2 illustrates the (optionally repeated and, in particular, periodic) outputting of an indication message 201 by the vehicle 100, in order to indicate that the set-up of a (BLE) communications link 112 with the vehicle 100 is enabled. FIG. 2 moreover shows a response message 202 which is transmitted by the device 110 to the vehicle 100 in response to the reception of an indication message 201, for the set-up of the communications link 112. Further to the set-up of the (BLE) communications link 112, messages 203, 204 can be exchanged between the vehicle 100 and the device 110 via the communications link 112, e.g. in order to remotely control a vehicle function 103.

As described above, a user of a vehicle 100 may wish to enable a service provider to execute the remote control of a vehicle function 103 of the vehicle 100, e.g. in order to initiate an automated (driverless) parking process of the vehicle 100, without the necessity for the handover of their electronic key device 110 to the service provider for this purpose.

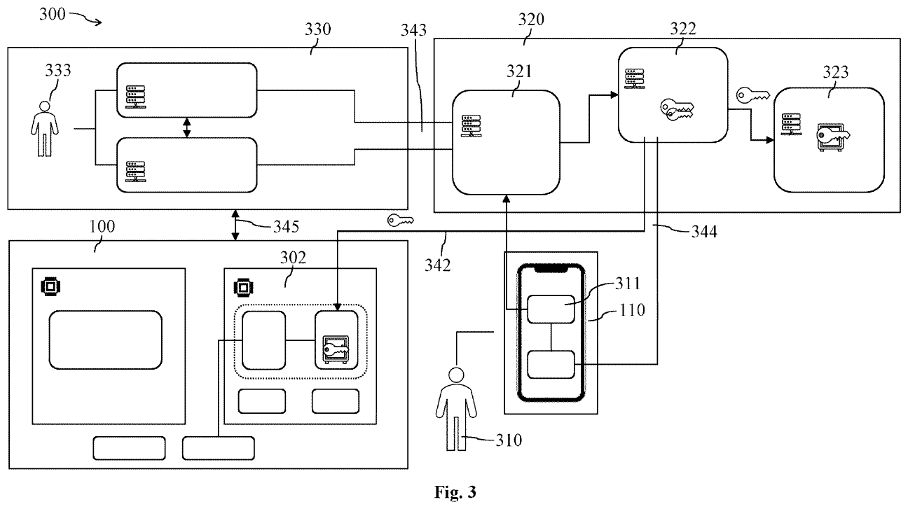

FIG. 3 shows an exemplary system 300 for the remote control of one or more vehicle functions 103 of a vehicle 100. The system 300 comprises at least one control unit 330 (e.g. having one or more computing units, for example servers) of a remote control service provider for remotely controlling at least one vehicle function 103 of the vehicle 100. The system 300 moreover comprises at least one controller 320 (e.g. having one or more computing units, for example servers) of a control entity (e.g. a manufacturer of the vehicle 100). The control unit 330 and the controller 320 can be configured for mutual communication via a communications link 343 (e.g. a hard-wired and/or wireless communications link). The controller 320 can be configured to communicate with the vehicle 100 via a (wireless) communications link 342, and/or to communicate with the key device 110 of the user 310 via a (wireless) communications link 344. The control unit 330 can be configured to communicate with the vehicle 100 via a (wireless) communications link 345. The individual communications links 342, 344, 345 can be respectively configured for remote communication (over a distance of 500 meters or more, in particular over 1 km or more, in particular over 10 km or more). The individual communications links 342, 344, 345 can be respectively comprised of multiple sections of different communications sub-links (e.g. in a wireless or hard-wired arrangement).

By way of a vehicle function 103, e.g. the release of an electronic immobilizer of the vehicle 100 can be initiated. In this context, the steering of the vehicle 100 can be released (e.g. by the release of a steering wheel lock). Alternatively or additionally, the motor controller of a drive motor of the vehicle 100 can be released.

A secure release of the electronic immobilizer typically requires that a correspondingly valid key 111 is present on a terminal device 110 (e.g. an ID transponder, a smartphone) in the immediate environment around or within the vehicle 100 which is to be released. From the locational and temporal presence of the key 111 on or in the vehicle 100, the intention of the user 310 for the movement of the secured vehicle 100. In general, a secure release of the immobilizer is only possible in the event that a correspondingly valid key 111, and thus also the user 310, prior to a journey which is to be executed, are temporally and locationally situated in immediate proximity to, or within the vehicle 100. In general, in the case of a driverless driving function, particularly in the event of operation by a service provider, this precondition is not fulfilled. In general, moreover, the user 310 and/or the terminal device 110 is/are not available for further releases of individual journeys (i.e. individual missions) of the vehicle 100 (e.g. on the grounds that the user 310 of the vehicle 100 has left a car park, and is located in an aircraft).

For the provision of a driverless driving function by a service provider, it is typically necessary that the immobilizer which secures the vehicle 100, even in the absence of an immediate locational and temporal presence of the, or of a correspondingly authorized key 111, can be released for travel in a previously agreed locational, temporal and/or application-related context. To this end, the intent of the user 310 to hand over an enablement for the release of the immobilizer of the vehicle 100 to an authentic and bona fide entity 330 (in particular to the control unit 330), for a specific duration and/or for a specific purpose, can be digitally and cryptographically secured and centrally saved (e.g. on the controller 320).

The user identity, duration of use, purpose of use, the affected vehicle 100 and/or the identifier of the automated driving system can be cryptographically saved in a session token or in a session signature which is held in trust in a central controller 320 (e.g. in a system which is provided on the vehicle manufacturer side, for example a vehicle backend). On request (e.g. originating from the vehicle 100), a contextual check can be executed and, in the event of a successful check, the key element associated with the vehicle 100 can be overridden, such that the immobilizer can be released by the vehicle 100.

The measures described in the present document can be employed e.g. in the context of an Automated Valet Parking (AVP) function 103. In AVP, the user 310 hands over the previously enabled vehicle 100 to the AVP parking system (i.e. to the control unit 330) in an AVP-enabled car park. The operator of the AVP parking system (i.e. the service provider) might optionally drive, or instruct the automated driving of the vehicle 100 during the stay thereof in the car park (e.g. for parking, reparking, for travel to a charging column or to a washing station, etc.). It is thus intended that the one or more individual journeys (i.e. missions) are executed with no further release on the part of the user 310 (e.g. on the grounds that the user 310 is unobtainable).

The user 310 has access to a terminal device 110 which supports the secure storage, administration and processing of cryptographic key material 111. In the context of a secure pairing process between the terminal device 110 and the vehicle 100, a cryptographic key pair can be generated, which pair enables the release of a vehicle function 103 (in particular, the release of the electronic immobilizer). One element of the key pair 111 remains in the secure administration function of the terminal device 110, and one element is delivered to the secure key administration function of the vehicle 100.

The key device 110 of the user 310 and the vehicle 100 can thus respectively comprise a key 111 which enables the user 310, by means of the key device 110, to remotely control one or more vehicle functions 103 (as represented in conjunction with FIGS. 1a, 1b and 2). These keys 111 can be employed for the enablement of a service provider (i.e. the control unit 330 of a service provider) to execute a remote control of a vehicle function 103 in the absence of a locational and/or temporal presence of the key device 110. To this end, in an enablement phase, key data for the enablement of remote control services can be generated and saved.

In the context of the enablement phase, the user 310 (via the communications link 344) can transmit a request from the key device 110 to the controller 330, in order to trigger the generation by the controller 320 of key data for a remote control service. The request can be generated by a software application 311 of the device 110. Moreover, the request can be transmitted to a service module 321 of the controller 320 and received by the service module 321. The request can be cryptographically signed by reference to the key 111 of the device, such that an administration module 322 of the controller 320 (for the administration of key data) can verify and confirm the authenticity of the request.

In the event of a successful confirmation, the controller 320, in particular the administration module 322, generates new cryptographic key material (i.e. key data for the remote control service). A first element remains in a secure memory module 323 of the controller 320, and a second element is delivered via a cryptographically secured data link (via the communications link 342) to a secure memory module 302 of the vehicle 100.

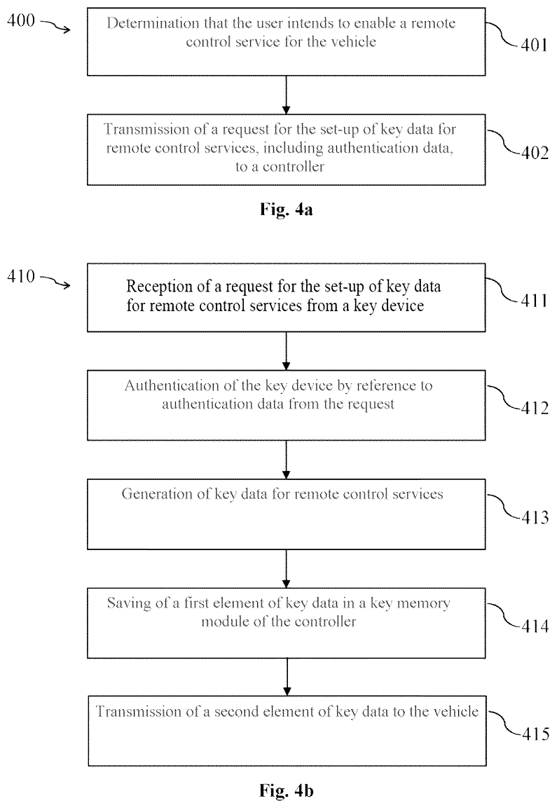

FIG. 4a shows an exemplary (and, optionally, computer-implemented) method 400 for enabling a remote control service. The method 400 can be executed by the key device 110. In the context of the method 400 (in step 401), it can be determined (e.g. on the basis of a user input) that the user 310 wishes to enable a remote control service. In response thereto, a (signed) request for the set-up of key data for a remote control service (in combination with authentication data) is transmitted by the key device 110 to the controller 320.

FIG. 4b shows an exemplary (and, optionally, computer-implemented) method 410 for enabling a remote control service. The method 410 can be executed by the controller 320. In a step 411, the request for the set-up of key data for a remote control service can be received by the controller 320. The request (in step 412) can be authenticated on the basis of authentication data (in particular on the basis of the signature). Further to successful authentication, key data can be generated (in step 413), and it can be initiated that a first element of key data is saved in the key memory module 323 of the controller 320 (in step 414) and that a second element of key data is transmitted to the vehicle 100 (in step 415).

FIG. 4c shows an exemplary (and, optionally, computer-implemented) method 420 for enabling a remote control service. The method 420 can be executed by the vehicle 100. The second element of key data (via the communications link 342) can be received by the vehicle 100 (in step 421), and can be saved in a key memory module 302 of the vehicle 100 (in step 422).

Subsequently to the fundamental enablement of a remote control service, a handover of the vehicle 100 to a remote control service provider, in particular to the control unit 330 of the remote control service provider, can be initiated.

It can be detected, e.g. by the control unit 330, that the vehicle 100 is located in a geographical region (for example in a car park) in which a remote control service can be initiated. The control unit 330 can indicate to the controller 320 (by means of an availability message) that the control unit 330 is available for the provision of a remote control service.

Alternatively or additionally, the key device 110 can transmit a handover request, for the handover of the vehicle 100 to the control unit 330 of the remote control service provider, to the controller 320, in particular to the service module 321 of the controller 320 (via the communications link 344). The handover request can comprise authentication data (e.g. a session signature). The handover request can moreover indicate contextual information, including one or more marginal conditions for the remote control service. Exemplary marginal conditions are as follows:
a geographical region within which the remote control service can be executed;
a time period within which the remote control service can be executed; and/or
one or more vehicle functions 103, the remote control of which is enabled in the context of the remote control service.

In the context of the handover request, the permissible context of the remote control service can be established accordingly.

Immediately prior to the handover of authority over the vehicle 100 by the user 310 to the control unit 330, the user 310 can thus be requested, on the terminal device 110, to confirm the handover to the control unit 330 for the remote control service (e.g. for one or more subsequent journeys). In the key administration function of the terminal device 110, by the employment of the saved key 111, a session signature can thus be generated and communicated to the controller 320. The session signature represents an application-related, context-related (with respect to place and time), and cryptographically secured statement of intent of the user 310 to release the immobilizer in a previously confirmed context. The controller 320 thus functions as a trustee for the user 310.

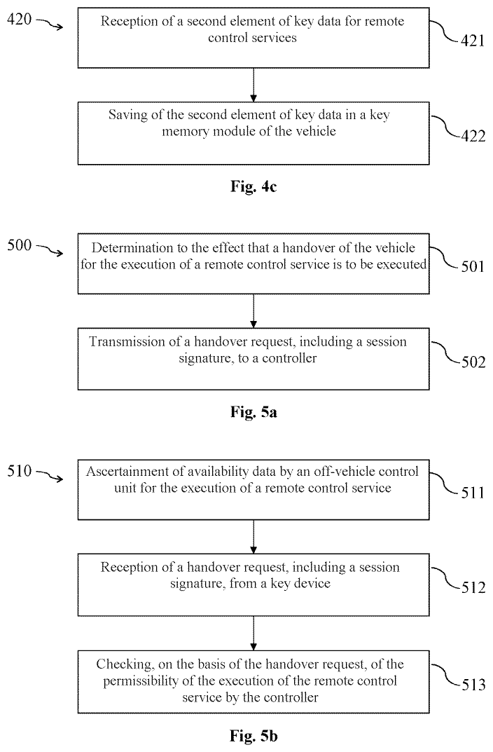

FIG. 5a shows an exemplary (and, optionally, computer-implemented) method 500 for the handover of the vehicle 100 to the control unit 330 of a remote control service. The method 500 can be executed by the key device 110. It can be determined by the key device 110 (in step 501) that the handover of the vehicle 100 to the control unit 330 for the execution of a remote control service is to be initiated. For example, the key device 110 can be notified by the controller 320 to the effect that the control unit 330 is available for the remote control service. Thereafter, a handover request including authentication data, in particular including a session signature, can be transmitted to the controller 320 (in step 502). The handover request can establish one or more marginal conditions (i.e. the context) of the remote control service (in the form of contextual information).

FIG. 5b shows an exemplary (and, optionally, computer-implemented) method 510 for the handover of the vehicle 100 to the control unit 330 of a remote control service. The method 510 can be executed by the controller 320. It can be ascertained that the control unit 330 is available for the execution of the remote control service (in step 511). This availability can be detected on the basis of availability data which are received by the control unit 330 (via the communications link 343). The key device 110 can then be notified of the availability of the control unit 330.

The method 510 further comprises the reception 512 of the handover request, including authentication data (in particular, including the session signature) which has been transmitted by the key device 110. The permissibility of the execution of the remote control service by the control unit 330 can then be checked (in step 513) on the basis of the handover request thus received, in particular on the basis of the session signature.

FIG. 5c shows an exemplary (and, optionally, computer-implemented) method 530 for the handover of the vehicle 100 to the control unit 330 of a remote control service. The method 530 can be executed by the control unit 330. It can be detected (in step 531) that a remote control service for a vehicle 100 is to be provided (e.g. on the grounds that the vehicle 100 is located within a specific geographical region, for example in a car park). Thereafter, availability data with respect to the availability of the control unit 330 for the execution of the remote control service can be transmitted to the control unit 330 which is associated with the vehicle 100 (in step 532).

Subsequently to the handover of the vehicle 100 to a control unit 330 for a remote control service, one or more missions (e.g. journeys) for the remote control of the vehicle 100 can be released. To this end, the control unit 330 can register a planned journey (in general, a mission) vis-à-vis the controller 320 (e.g. by the transmission of a mission request). In the event that the mission request corresponds to the context which has previously been saved in the session signature (and thus fulfils one or more established marginal conditions), the controller 320 can thus notify the vehicle 100 to the effect that a valid mission is involved. The vehicle 100 can confirm the mission, and can request the communication of the second key element, which key element is necessary for the release of the vehicle function 103 which is to be remotely controlled (in particular, for the release of the immobilizer).

The session signature can be transferred to the key administration module 322, which module, further to a successful integrity and authenticity check, communicates the vehicle-specific key element to the vehicle 100, such that the remote control of the vehicle function 103, in particular the release of the immobilizer, can be executed. This method can be repeated in the context of the validity of the session signature (for a plurality of missions).

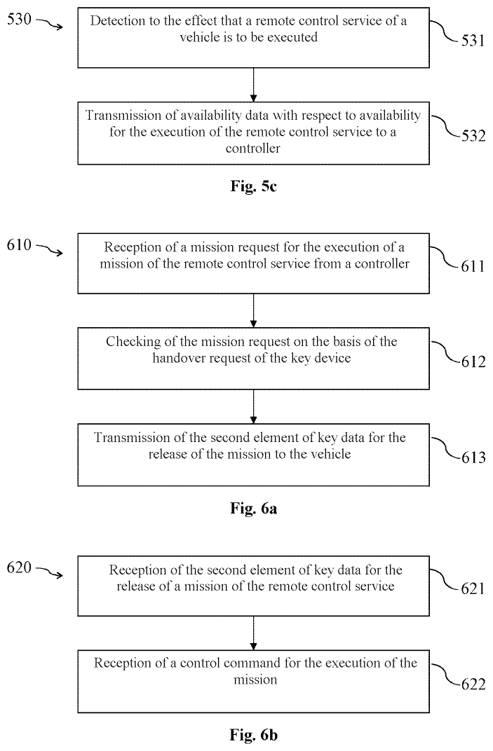

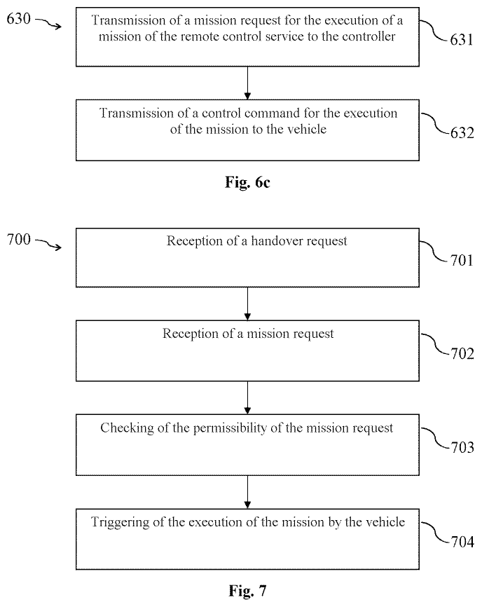

FIG. 6a shows an exemplary (and, optionally, computer-implemented) method 610 for the release of a mission of the remote control service. The method 510 can be executed by the controller 320. The method 510 comprises the reception 511 of a mission request for the execution of a mission of the remote control service. The mission request can be checked in consideration of the saved context for the remote control service (in step 612). Further to a successful check, the second element of key data can be transmitted to the vehicle 100, in order to release the mission of the remote control service (in step 613).

FIG. 6b shows an exemplary (and, optionally, computer-implemented) method 620 for the release of a mission of the remote control service. The method 620 can be executed by the vehicle 100. In the context of the method 620, the second element of key data can be received by the vehicle 100 (in step 621). This can be interpreted as a release for the mission of the remote control service. Thereafter, the execution of the mission, in particular the release of the electronic immobilizer, can be initiated. Moreover, one or more control commands can be received by the control unit 330 (in step 622). The vehicle function 103 can be controlled in accordance with the one or more control commands.

FIG. 6c shows an exemplary (and, optionally, computer-implemented) method 630 for the release of a mission of the remote control service. The method 630 can be executed by the remote control unit 330. The method 630 comprises the transmission 631 of a mission request for a mission of the remote control service to the controller 320. The method 630 can further comprise the transmission 632 of one or more control commands for the execution of the mission to the vehicle 100.

The release of the remote control service can be terminated by the expiry of the (temporal) validity of the session signature. Alternatively or additionally, the release can be terminated in response to a termination request of the vehicle 100 and/or of the controller 320 and/or of the key device 110. Thereafter, the session signature can be tagged as invalid (within the memory module 323).

FIG. 7 shows an exemplary (and, optionally, computer-implemented) method 700 for enabling a remote control service for a motor vehicle 100 or for the remote control of a motor vehicle 100. The method 700 can be executed by the controller 320. The method 700 can comprise one or more (arbitrary) steps from the methods 410, 510 and/or 610.

The method 700 comprises the reception 701, 512 of a handover request which is transmitted by the key device 110 for the handover of the motor vehicle 100 to the remote control service, in particular to the control unit 330 of the remote control service (in order to enable and/or initiate a remote control of the motor vehicle 100 by the remote control service). The handover request can comprise contextual information with respect to the permissible context of the remote control service (including e.g. the permissible geographical range and/or the permissible time period).

The method 700 further comprises the reception 702, 611 of a mission request for a mission of the remote control service for the remote control of the motor vehicle 100 which is transmitted by the remote control service, in particular by the control unit 330 of the remote control service, and a check 703, 612 of the permissibility of the mission request on the basis of contextual information.

The method 700 moreover comprises, in accordance with the check 703, 612, the triggering 704, 613 of the execution by the vehicle 100 of the mission of the remote control service (which is initiated and/or requested by the control unit 330). In particular, in the event of a successful check of the mission request, the second element of key data can be transmitted to the vehicle 100, in order to enable the execution of the mission of the remote control service (in particular by the release of the electronic immobilizer of the vehicle 100).

By means of the measures described in the present document, an efficient, reliable and secure remote control of one or more vehicle functions 103 by a remote control service provider can be effected (in the absence of the locational presence of a digital key device 110).

The present invention is not limited to the exemplary embodiments represented. In particular, it should be observed that the description and the figures are only provided by way of an exemplary illustration of the principle of the methods, devices and systems proposed.

1.-14. (canceled)

15. A method for enabling a remote control service for remote control of a motor vehicle, the method comprising:
receiving a handover request, which handover request is transmitted by a key device, for handover of the motor vehicle to a remote control service, wherein the handover request comprises contextual information regarding a permissible context for the remote control service;
receiving a mission request for a mission of the remote control service which is transmitted by the remote control service for the remote control of the motor vehicle;
checking the permissibility of the mission request, on the basis of contextual information; and
depending upon the checking, triggering execution by the vehicle of the mission of the remote control service.

16. The method according to claim 15, further comprising:
receiving a cryptographic session signature of the key device, in combination with the handover request; and
verifying the handover request and/or contextual information, including the authenticity of the handover request and/or of contextual information, on the basis of the cryptographic session signature.

17. The method according to claim 16, wherein:
the session signature is based upon a digital key of the key device; and
the digital key is configured in accordance with a Car Connectivity Consortium (CCC) key standard, in accordance with CCC Release 3.

18. The method according to claim 15, wherein the contextual information indicates:
a permissible geographical range for one or more missions of the remote control service;
a permissible time period for one or more missions of the remote control service; and/or
one or more vehicle functions of the vehicle, the remote control of which by a control unit is permitted in the context of a mission of the remote control service.

19. The method according to claim 15, wherein the mission request for the mission of the remote control service indicates:
a geographical range of the mission;
a duration of the mission; and/or
one or more vehicle functions of the vehicle, the remote control of which by a control unit is to be executed in the context of the mission.

20. The method according to claim 15, further comprising:
receiving a request for a set-up of key data for enablement of the vehicle for remote control services;
generation of key data;
saving of a first element of key data in a key memory module of a controller; and
transmission of a second element of key data to the vehicle.

21. The method according to claim 20, further comprising:
receiving authentication data for authentication of the key device, in combination with the request, wherein authentication data are based upon a digital key of the key device;
authenticating the request on the basis of authentication data; and
further to the authentication of the request, generation of key data.

22. The method according to claim 15, wherein the method comprises the transmission to the vehicle of a first element of key data for enablement of the vehicle for remote control services, which first element is saved in a key memory module of a controller, in order to trigger the execution by the vehicle of the remote control service.

23. The method according to claim 15, wherein the method comprises, depending upon the checking, a triggering of the vehicle for the release of an electronic immobilizer of the vehicle, in order to execute the mission of the remote control service.

24. The method according to claim 15, further comprising:
receiving availability data which have been transmitted by the remote control service, to the effect that a control unit is available for provision of the remote control service;
transmitting availability information with respect to availability data thus received to the key device; and
receiving the handover request in response to the transmission of availability information.

25. A controller for enabling a remote control service for remote control of a motor vehicle; comprising:
a computer-implemented controller operatively configured to:
receive a handover request which is transmitted by a key device for a handover of the motor vehicle to a remote control service, wherein the handover request incorporates contextual information with respect to permissible context for the remote control service;
receive a mission request for a mission of the remote control service for the remote control of the motor vehicle which is transmitted by the remote control service;
execute a check of the permissibility of the mission request, on the basis of contextual information; and
depending upon the check, trigger execution of the mission of the remote control service.

26. A key device of a user of a motor vehicle, comprising:
the key device being operatively configured to:
transmit a handover request for handover of the motor vehicle to a remote control service, wherein the handover request incorporates contextual information with respect to a permissible context for the remote control service.

27. A control unit for provision of a remote control service for remote control of a motor vehicle; comprising:
the control unit operatively configured to:
transmit a mission request for a mission of the remote control service for the remote control of the motor vehicle to a controller for enablement of the remote control service.

28. A motor vehicle, comprising:
one or more functions which are remotely controllable;
wherein the motor vehicle is operatively configured to: be triggered by an off-vehicle controller for execution of a mission of a remote control service for the remote control of the motor vehicle.
